(19) United States
(12) Patent Application Publication
(10) Pub. No.: US 2007/0101627 A1
(43) Pub. Date: May 10, 2007

(54) Overhead advertising display system with translation movement over a rail

(76) Inventor: Juan Fernando Gutierrez Lomelin, Santiago de Queretaro (MX)

Correspondence Address: WALTER K. ROLOFF, 490 HARBOR COURT, SHOREVIEW, MN, 55126, US

(21) Appl. No.: 11/586,301

(22) Filed: Oct. 25, 2006

(30) Foreign Application Priority Data
Oct. 25, 2005 (MX) PA/U/2005/000258

(51) Int. Cl. G09F 7/22

(52) U.S. Cl. 40/617

(57) ABSTRACT

An overhead advertising display system with translation movement over a rail includes means for moving at least one advertising sign along a rail track, at least one cart mounted in the rail track and pulled by a traveling cable located inside the rail track, and at least one tractor to drive said cable, communicating its movement through friction.

### FOREIGN PRIORITY CLAIM

The present application hereby claims the benefit of foreign priority in Mexican Patent Application utility model no. PA/u/2005/000258 filed in Mexico on 25 Oct., 2005, with the entirety thereof being incorporated herein by reference thereto.

### FIELD OF THE INVENTION

The present invention relates generally to display systems. The invention relates specifically to an overhead advertising display system with translation movement over a rail. In particular, the display system of the present invention allows a two-side view and a constant and slow translation movement, which thereby allows viewers to simultaneously watch, within their own viewing field, a group of, for example, either different or equal advertising signs, or a combination thereof.

### BACKGROUND OF THE INVENTION

Known display systems generally comprise: (i) mere fixed signs mounted on walls or diverse structures; (ii) static, small, window-framed single-cabinet displays, with or without lights, placed at a typical height of an observer; (iii) static, small, window-framed single-cabinet displays, with or without lights, placed at a typical height of an observer, operating a blind system having typically triangular blinds and viewing faces, or similar mechanisms, which, for example, sequentially show a limited number of advertising signs (e.g., from three to six different pictures); or (iv) small, window-framed, single-cabinet displays, with or without lights, placed at a typical height of an observer, operating with an inner canvas belt moved by rollers, which, for example, sequentially show a limited number of advertising signs (e.g., from ten to fifteen different pictures).

These known display systems typically suffer from at least one of several common limitations. For some known systems, due to their size and location, only a limited number of observers can watch them since a first or front line of observers usually obstructs visibility for potential observers behind them (few observers). Also, in some known systems, only a limited number of advertising signs and advertisers are possible (few variety and few sponsors). Further, known display systems with sequential projection of images commonly experience difficulty in achieving a satisfactory balance between a variety of signs displayed and a duration of display for each one, because: (a) if time periods for changing signs are programmed to be too short, images on the signs will not have enough time to generate message retention for observers; and (b) if time periods for changing signs are programmed to be too long, images on the signs may bore observers who are waiting for signs to change. In both cases, a result is often a loss of observers' interest in the signs being displayed.

Therefore there exists a need for an overhead advertising display system with translation movement over a rail, which overcomes the aforementioned drawbacks of the known display systems.

### SUMMARY OF THE INVENTION

An object of the present invention is to provide an overhead advertising display system with translation movement over a rail which may be readily watched by a relatively large number of observers.

Another object of the present invention is to provide an overhead advertising display system with translation movement over a rail which may readily display a relatively large number of advertising signs for a relatively large number of advertisers, for increased variety and sponsorship.

A further object of the present invention is to provide an overhead advertising display system with translation movement over a rail which achieves a satisfactory balance between a variety of signs displayed and a duration of display for each one.

A yet further object of the present invention is to provide an overhead advertising display system with translation movement over a rail which promotes observers' interest in the signs being displayed.

In accordance with the present invention, an overhead advertising display system with translation movement over a rail includes means for moving at least one advertising sign along a rail track, at least one cart mounted in the rail track and pulled by a traveling cable located inside the rail track, and at least one tractor to drive said cable, communicating its movement through friction.

### BRIEF DESCRIPTION OF THE DRAWINGS

FIG. 1 is an isometric projection view of an overhead advertising display system with translation movement over a rail, constructed in accordance with the present invention.

FIG. 2 is a cross-section view of an exemplary aluminum rail component of the invention.

FIG. 3 is longitudinal-section view of the exemplary aluminum rail component of FIG. 2.

FIG. 4.1 is a longitudinal-section view of an exemplary horizontal curved rail component of the invention.

FIG. 4.2 is a cross-section view of the exemplary horizontal curved rail component of FIG. 4.1.

FIG. 5 is a vertical cross-section view of an exemplary tractor component of the invention.

FIG. 6 is a horizontal cross-section view of the exemplary tractor component of Fig.5.

FIG. 7.1 is a longitudinal-section view of a vertical curve of an exemplary rail component of the invention.

FIG. 7.2 is a cross-section view of a vertical curve of the exemplary rail component of Fig.7.1.

FIG. 8 is a depiction of exemplary electrification elements of the invention.

### DETAILED DESCRIPTION OF THE INVENTION

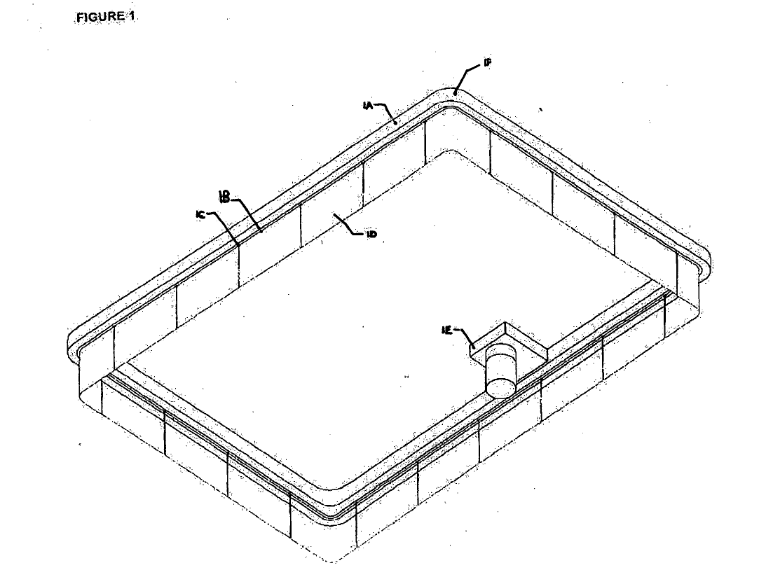

FIG. 1 shows, in isometric projection, a particular exemplary embodiment of an overhead advertising display system with translation movement over a rail of the present invention, as a rectangular-shaped circuit, in a horizontal plane. In FIG. 1, the exemplary embodiment includes a circuit for moving advertising signs in a single horizontal and rectangular plane; the exemplary overhead advertising display system with translation movement over a rail is operated by moving the advertising signs along a rail track, by means of carts mounted in the track being pulled by a traveling cable located inside the rail. The cable in turn is driven by a tractor that communicates its movement through friction. The rail track can be of any shape, according to shapes and dimensions of an installation site for the system. Preferably, the rails may be attached to soffits, ceilings, wall-mounted corbels, or self-supporting structures.

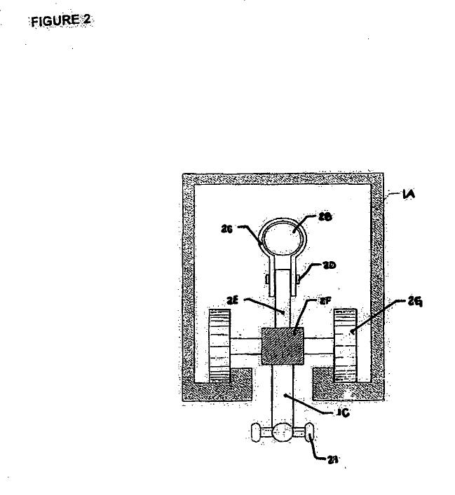

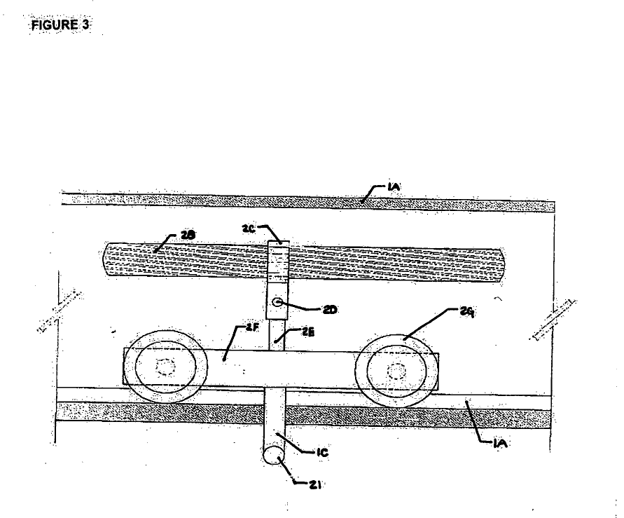

Referring to FIGS. 2 and 3, the advertising signs are hung from “traveling supports” (1c) which are in turn hung from the carts.

The translation movement may be in both directions and at variable speeds, which are adjusted for each installation site.

Each advertising sign may be provided with electricity by insulated terminals alternately located in every other cart, in order to provide them with separate lighted images having their own illuminating sequence program. In an exemplary advertising system embodying an overhead advertising display system with translation movement over a rail of the present invention, several advertising images may be simultaneously shown, and due to its location and size, the path of the system covers most of its viewing field from different angles, and is visible for a longer time.

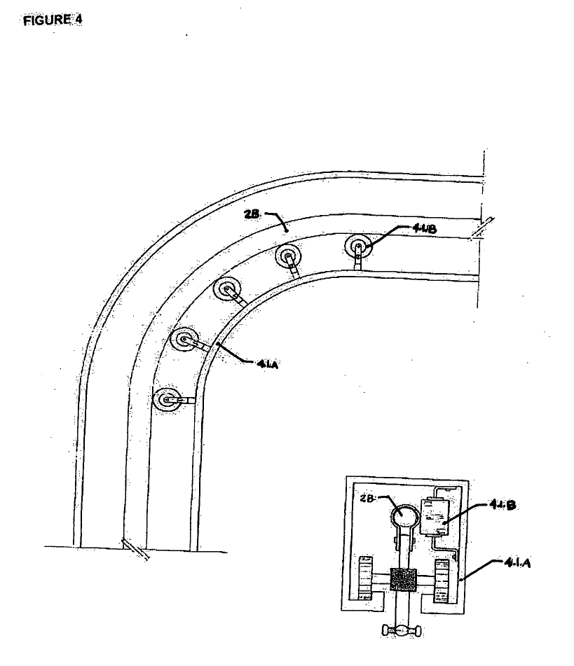

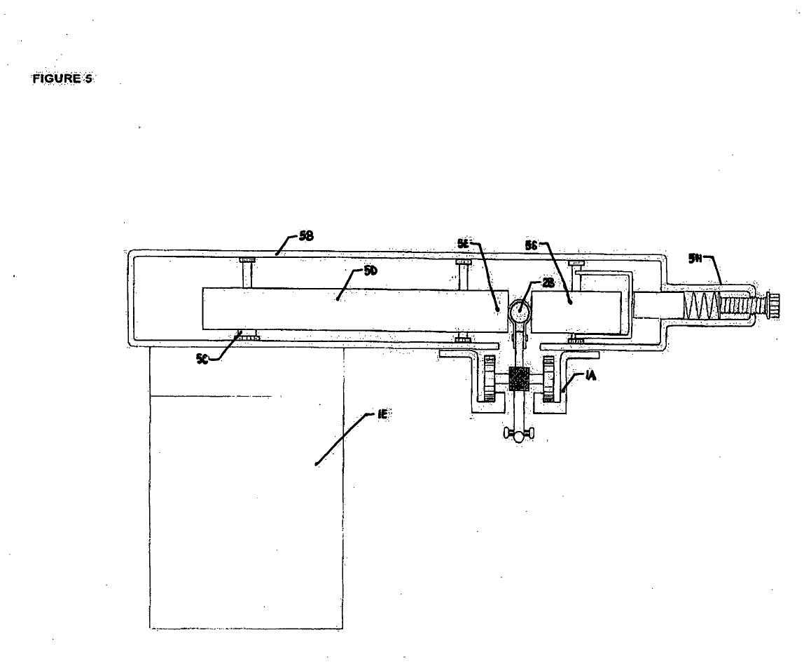

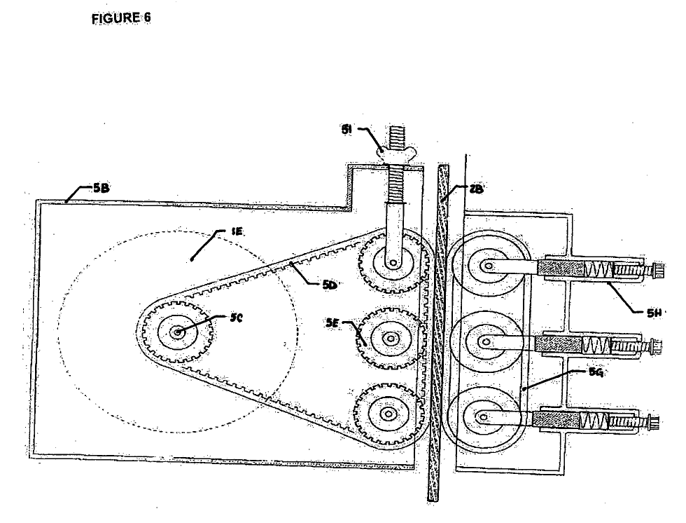

Referring again to FIG. 1, the exemplary circuit is made up of straight sections of rail (1a), having a gap at its bottom part (1b) through which traveling supports pass through (1c) whose main function is to hold the advertising signs (1d). As shown in FIG. 2, the signs are carried by each cart wherein upper parts of the carts are fixed to an iron cable (2b) which is moved by a 120v direct current power motor (1e) as shown in FIGS. 5 and 6 through straight stretches of rail (1a) and horizontal curves (1f) as shown in FIGS. 4.1 and 4.2. They may vary according to needs of a particular installation site, wherein combined circuits may be used in horizontal and slope planes forming a closed path of irregular shape. FIG. 4.1 depicts a longitudinal section of an exemplary horizontal curved rail component of the invention, showing bearings there within to prevent the carts from turning over.

The translation speed shall always be relatively slow, within a variable range, depending on the size of the signs to favor viewing the same. The direction of movement may be switched to make the viewing action more attractive and versatile to observers.

Referring again to FIGS. 5 and 6, tractor (5b) is shown inserted into a straight stretch of the rail; the tractor, whose capacity and motor force are provided by its shaft (5c), moves the advertising signs in both directions by means of friction belts (5d) and (5g). They are moved by pulleys (5e) wherein a frictional force is adjustable via press screws (5h) and a screw shackle (6I). The tractor is movable by a reversible-rotation variable-speed motor (1e). This reversible and variable-speed movement is considered a unique feature of the system.

With reference to FIGS. 2, 3, 5, and 6, traveling iron cable (2b) housed inside the rail is dragged by the tractor. Movement thereof is communicated to the carts attached thereto by means of a clamp (2c) fixed to a pole (2e) which is in turn connected to a cart body (2f) by a rivet (2d) thereby permitting the cart to slide by the inner part of the rails by means of tires (2g) fitted at both ends of each cart.

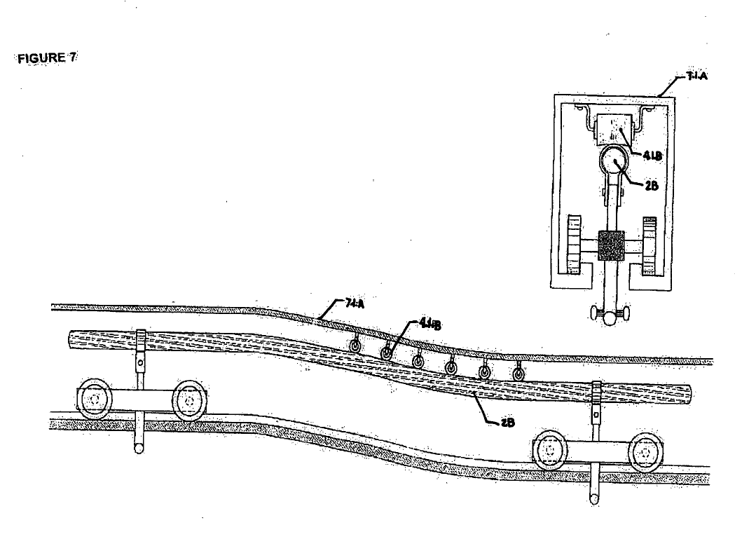

Referring now to FIGS. 4.1 and 4.2, and to FIGS. 7.1, and 7.2, the traveling cable will always maintain its place at the straight sections and curves (4.1.A and 7.1.A); and it will also maintain its position by means of support provided by support bearings (4.1.b) installed in the inner part of the curves (4.1.a). In particular, in FIG. 7.1, a longitudinal-section view of a vertical curve of the exemplary rail component of the invention is depicted, going downward and showing bearings there within to prevent the cable from going up and the carts from losing contact with the track.

With reference again to FIGS. 1, 2, and 3, there are “traveling supports” at the bottom part of the carts (1c), featuring a hook to hold the signs (2i) which travel overhead by following the rail track, dragged by the mechanism apparatus.

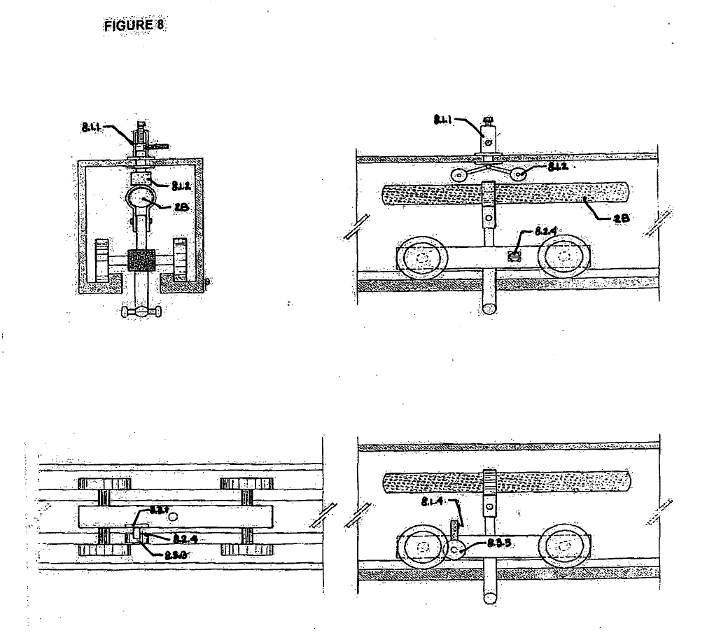

Referring to FIG. 8.1, to provide 127 VAC power to each sign the following exemplary steps are followed:

1. Firmly connect the set of rails to the neutral terminal of the power supply.

2. Place a current outlet (8.1.1) and a double spinning brush (8.1.2) near the tractor, and connect it to the current terminal of the power system. The brush shall permanently be in contact with the traveling cable inside the rail, thus polarizing the body of the carts, which in turn are to remain insulated from counter-polarity by means of nylon casters.

3. Every two carts will alternately carry attached to one side a small insulating block with an insulation capacity of 600 V (8.3.1) which is the support for a spinning brush which shall be in permanent contact with the rail (8.3.3) to obtain neutral polarity; but isolated from the current polarity so that both polarities are alternately available in the body of every two carts. These polarities are picked up by means of screw-like terminals (8.2.4) having 600 Volt-capacity insulated cables for each polarity, which may be available to power each of the signs as required, to highlight their pictures with LEDs.

The signs, in turn, shall be manufactured with non-conducting materials to ease their handling and prevent accidents. The LEDs can be programmed to have variations in tonality and/or in an on-off sequence to allow the graphics appear in motion.

Some general observations are applicable to any embodiment of the present invention. In this regard, it is to be appreciated that the invention as aforedescribed overcomes the aforementioned drawbacks of known display systems and permits display to relatively large groups of observers due to, inter alia, the system's size and location above the observers. Further, an ability of the present invention to simultaneously display a relatively large number of signs in turn generates heightened interest in, and increased display time for, the observers.

The size and mounting height of the present invention may be preferably chosen with regard to particular dimensions and features of a display site; and it may preferably be installed indoors.

It is to be particularly appreciated and understood that in the overhead advertising display system with translation movement over a rail of the present invention, advertising materials are shown in overhead signs that move forward in a line following a closed path. The path may be only horizontal or a combination of horizontal and sloped lengths, with features of the installation site determining the path shape. Longer or shorter lengths can be covered, as the site may require, so that large groups of advertising signs can be simultaneously seen by a given number of observers.

Translation movement of the signs will be generated by linear longitudinal movement of a series of carts that travel while keeping an even separation from each other over a closed rail path. The carts have a longitudinal slot at the bottom part and an inner rolling track as a guide for movement. A “traveling support” protrudes downward from the inner slot of each cart in a vertical position, which serves to hang on the advertising signs; two or more “traveling supports” may be used per sign.

At the lower part of pole (2e), the carts are attached to a traction cable located within the rail forming a closed circuit. The traction cable is dragged by friction through double caterpillar-track mechanisms (tractors), which in turn are moved by a variable speed, rotation-reversible motor. Each system will have the necessary number of tractors to provide smooth and continuous movement.

The rail may be adapted in shape and length to the requirements of any particular installation, since it may have straight stretches of different lengths, vertical curves for upward and downward travel, and curves on the horizontal plane.

In order to avoid distortion of the signs while passing through horizontal and vertical curves, a flexible glass fiber rod is attached to each sign, by inserting the rod into a horizontal casing which is sewed all along the upper edge of the sign.

The rails may be supported by superimposing them on soffits or flagstones, or by placing them on wall-mounted corbels, or by attaching them to floor-based self-standing structures, as may be preferred with respect to the planned path for the rails.

The rails are electrically connected to the neutral terminal of a 127 V single-phase system, while a brush insulated from the rails is placed over the traction cable of the carts having a polarity of 127 VAC. Thus, this element has a potential difference of 127 V with respect to the rail. Each cart will become polarized by means of the traction cable potential, but insulated from the rails through their nylon casters.

To complement the electrification, every other cart will have an insulated brush holder, containing a circle brush in constant contact with the rail. Thus, every two carts will provide both polarities: neutral and current terminals. Furthermore, a length of insulated cable derives from each terminal, the ends of which provide the required voltage to each sign in order to enhance the advertising signs by means of LED lightning.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired results, or that various accessories may be added thereto.

Lastly, the choice, of course, of compositions, sizes, and strengths of various aforementioned components of the present invention are all a matter of design choice depending upon intended uses thereof.

Accordingly, these and other various changes or modifications in form and detail of the present invention may also be made therein, again without departing from the true spirit and scope of the invention as defined by the appended claims.

I claim:

1. An overhead advertising display system with translation movement over a rail, comprising:
means for moving at least one advertising sign along a rail track;
at least one cart mounted in the rail track and pulled by a traveling cable located inside the rail track; and
at least one tractor to drive said cable, communicating its movement through friction.

2. The overhead advertising display system with translation movement over a rail of claim 1, wherein said rail track can be of any shape according to a shape and dimensions of an installation site.

3. The overhead advertising display system with translation movement over a rail of claim 1, wherein said rail track is attached to one of a group consisting of soffits, ceilings, wall-mounted corbels, and self-supporting structures.

4. The overhead advertising display system with translation movement over a rail of claim 1, wherein said at least one advertising sign is hung from at least one traveling support which is, in turn, hung from the at least one cart.

5. The overhead advertising display system with translation movement over a rail of claim 1, wherein said translation movement may be in both directions and at variable speeds which are adjusted for each installation site.

6. The overhead advertising display system with translation movement over a rail of claim 1, wherein said at least one advertising sign is selectively provided with electricity by means of alternately located insulated terminals for provision of separate lighted images having discrete illuminating sequence programs.

7. The overhead advertising display system with translation movement over a rail of claim 1, wherein a plurality of advertising images may be shown.

8. The overhead advertising display system with translation movement over a rail of claim 1, wherein a path of said rail track covers a selected portion of a viewing field from a plurality of angles which is visible for a relatively long time.

9. An overhead advertising display system with translation movement over a rail, comprising simultaneous display of a plurality of advertising images thereby increasing interest of observers therein.

10. The overhead advertising display system with translation movement over a rail of claim 9, further comprising at least one aluminum rail to provide a display shape and house advertising signs transporting carts which are, in turn, fixed to an iron cable covering a length of said advertising display.

11. The overhead advertising display system with translation movement over a rail of claim 9, further comprising at least one support bearing placed inside said rail in a vicinity of at least one curve thereof, to maintain the iron cable in place thereat.

12. The overhead advertising display system with translation movement over a rail of claim 10, further comprising a variable power 120v direct current power motor conformed by pulleys that are in charge of moving pressing belts to move said iron cable to which said at least one cart is fixed, with said at least one cart being specifically designed to travel and transport through said rail said advertising signs fixed thereto by means of hooks at the bottom part of each said cart.

13. The overhead advertising display system with translation movement over a rail of claim 9, wherein a location of said advertising signs above observers allows that virtually everyone in the installation site of the display system may watch the advertising images within their own viewing field, for a great part of the advertising sign travel path.

14. The overhead advertising display system with translation movement over a rail of claim 9, wherein said system:
attracts attention of a larger number of observers for a longer time, thus increasing efficiency of observation-decision making processes;
replaces a flat impression with a three-dimensional impression;
replaces a static display with a mobile display, to vary in size and shape, to avoid visual barriers due to height of the installation place;
creates several advertising spaces by using only one system; and
provides life, movement, and dynamism to a static space like the aerial space.
